(19) United States
(12) Patent Application Publication
(10) Pub. No.: US 2016/0045054 A1
(43) Pub. Date: Feb. 18, 2016

(54) Portable Cooking Container

(71) Applicant: David Su, Chino, CA (US)

(72) Inventor: David Su, Chino, CA (US)

(21) Appl. No.: 14/594,079

(22) Filed: Jan. 10, 2015

Related U.S. Application Data
(60) Provisional application No. 62/038,179, filed on Aug. 15, 2014.

(51) Int. Cl. A47J 27/10

(52) U.S. Cl. CPC A47J 27/10

(57) ABSTRACT

A portable cooking container includes an external container body, an internal container body, and a lid unit. The external container body includes an external wall structure having an external cavity formed within the external wall structure, the external wall structure comprising a first external surrounding wall and a second external surrounding wall. The internal container body is detachably received in the external cavity, and has at least one internal surrounding wall to define an internal cavity within the internal surrounding wall. The internal container body has a plurality of blocking sections circumferentially formed on an upper portion of the internal container body. The lid unit is shaped and sized to fittedly cover the external container body, and includes a venting mechanism for allowing steam to be vented out of the portable cooking container.

### CROSS REFERENCES TO RELATED APPLICATIONS

This is a non-provisional application which claims priority under 35 U.S.C. §119 to a provision application having an application serial number of 62/038,179 and a filing date of Aug. 15, 2014. The contents of this specification is incorporated herein by reference.

### BACKGROUND OF THE PRESENT INVENTION

1. Field of Invention

The present invention relates to a container, and more particularly to a portable cooking container which is capable of allowing a user to heat up food or liquid in the container anywhere and anytime.

2. Description of Related Arts

A conventional container usually comprises a container body, and a lid covering on the container body to form an enclosed cavity for storing a predetermined amount of food or liquid. Very often, this conventional container is equipped with certain kinds of technology or arrangements which may thermally insulate the enclosed cavity from ambient environment. However, the major disadvantage of this type of conventional container is that it can only maintain a temperature of the enclosed cavity for a certain period of time. When the temperature of the enclosed cavity lowers, it is not possible to increase the temperature of the enclosed cavity again without putting in hot food or beverages.

U.S. patent application, publication number US2014/0261381 to Ra discloses a heating container which includes a main body in which a heating element is inserted and water is poured, a built-in container inserted into the main body, and a sealing cover sealing an opened upper portion of the built-in container. The vapor generated when water within the main body is boiled is discharged between the main body and the built-in container.

There are several disadvantages which may be identified in Ra. First, the outer layer of the main body has a single wall structure. When water within the main body is heated up, a substantial amount of heat and steam will be generated. A single wall structure allows heat to be easily conducted to an outer surface of the main body. This causes a major safety concern especially for children.

Second, the sealing cover disclosed Ra is not equipped with any mechanism for preventing suction of the sealing cover. When the main body is heat up, steam will try to escape from the main body, causing the pressure inside the main body to drop. The pressure differential between the interior of the main body and its exterior causes the sealing cover to be sucked downwardly.

Third, Ra does not indicate how much water is to be filled in the main body. When too much water is filled in the main body, water and steam will easily splash out from the maim body which may cause safety concern. Moreover, water may also easily splash into the built-in container and mix with the food or liquid contained therein.

Fourth, from the disclosure contained in Ra, the heating container disclosed therein does not have any mechanism in preventing steam from being effectively vented out of the main body during cooking or heating.

As a result, there is a need to have a portable cooking container which can tackle the above-mentioned problems.

### SUMMARY OF THE PRESENT INVENTION

An objective of the present invention is to provide a portable cooking container which is capable of allowing a user to heat up food or liquid in the container anywhere and anytime.

Another objective of the present invention is to provide a portable cooking container comprising an external container body which defines a double-wall structure for substantially insulating the portable cooking container. This ensures that users of the present invention will not be burnt by the heat generated within the portable cooking container.

Another objective of the present invention is to provide a portable cooking container comprising a rim arrangement for effectively preventing water in the external container body to be splashed out therefrom. As a result, the present invention provides a substantially improved safety feature as compared to conventional arts.

Another objective of the present invention is to provide a portable cooking container comprising an external container body, an internal container body, and a lid unit, wherein steam generated in the internal container body can only escape through a venting mechanism provided on the lid unit.

Another objective of the present invention is to provide a portable cooking container comprising an external container body which comprises a first external surrounding wall and a second external surrounding wall for forming the double-wall structure, wherein the first external surrounding wall and the second external surrounding wall are selectively detachable from each other so as to provide two separate containers of the external container body.

Another objective of the present invention is to provide a portable cooking container which may be embodied as a cooking lunch box or a heating cup.

In one aspect of the present invention, it provides a cooking container, comprising:

an external container body comprising an external wall structure having an external cavity formed within the external wall structure, the external wall structure comprising a first external surrounding wall and a second external surrounding wall;

an internal container body detachably received in the external cavity, the internal container body having at least one internal surrounding wall to define an internal cavity within the internal surrounding wall, a height of the internal container body being smaller than that of the external container body to form a heating space between the internal container body and the external container body, the internal container body having a plurality of blocking sections circumferentially formed on an upper portion of the internal container body, the external container body and said internal container body being separated by a predetermined distance; and

a lid unit being shaped and sized to fittedly cover the external container body, the lid unit comprising a venting mechanism for allowing fluid to be discharged out of the portable cooking container;

whereby when a heating element and water are placed in the heating space and a food item is placed in the internal cavity, the heating element is arranged to heat up the food item in the internal container body, in such a manner that water in the heating space is blocked by the blocking sections from splashing out of the portable cooking container, while fluid in the internal container body is guided to exit the portable cooking container through the venting mechanism.

### BRIEF DESCRIPTION OF THE DRAWINGS

FIG. 1 is a perspective view of a portable cooking container according to a first preferred embodiment of the present invention.

FIG. 2 is an exploded side view of the portable cooking container according to the first preferred embodiment of the present invention.

FIG. 3 is a schematic diagram of the external container body of the portable cooking container according to the first preferred embodiment of the present invention.

FIG. 4 is a schematic diagram of the internal container body of the portable cooking container according to the first preferred embodiment of the present invention.

FIG. 5 is a sectional side view of the external container body of the portable cooking container according to the first preferred embodiment of the present invention.

FIG. 6 is a sectional side view of the internal container body of the portable cooking container according to the first preferred embodiment of the present invention.

FIG. 7 is a schematic diagram of the portable cooking container according to the first preferred embodiment of the present invention.

FIG. 8 is a perspective view of lid unit of the portable cooking container according to the first preferred embodiment of the present invention, illustrating a top side of the lid unit.

FIG. 9 is a perspective view of lid unit of the portable cooking container according to the first preferred embodiment of the present invention, illustrating a bottom side of the lid unit.

FIG. 10 is an alternative mode of the portable cooking container according to the first preferred embodiment of the present invention.

FIG. 11 illustrates a double wall structure of the external container body according to the alternative mode of the first preferred embodiment of the portable cooking container.

FIG. 12 is a perspective view of a portable cooking container according to a second preferred embodiment of the present invention.

FIG. 13 is an exploded side view of the portable cooking container according to the second preferred embodiment of the present invention.

FIG. 14 is a schematic diagram of the external container body of the portable cooking container according to the second preferred embodiment of the present invention.

FIG. 15 is a schematic diagram of the internal container body of the portable cooking container according to the second preferred embodiment of the present invention.

FIG. 16 is a sectional side view of the external container body of the portable cooking container according to the second preferred embodiment of the present invention.

FIG. 17 is a sectional side view of the internal container body of the portable cooking container according to the second preferred embodiment of the present invention.

FIG. 18 is a schematic diagram of the portable cooking container according to the second preferred embodiment of the present invention.

FIG. 19 is a perspective view of lid unit of the portable cooking container according to the second preferred embodiment of the present invention, illustrating a bottom side of the lid unit.

FIG. 20 is a perspective view of lid unit of the portable cooking container according to the second preferred embodiment of the present invention, illustrating a top side of the lid unit.

FIG. 21 is an alternative mode of the portable cooking container according to the second preferred embodiment of the present invention.

FIG. 22 illustrates a double wall structure of the external container body according to the alternative mode of the second preferred embodiment of the portable cooking container.

FIG. 23 illustrates is another schematic diagram of the portable cooking container according to the alternative mode of the second preferred embodiment of the portable cooking container.

### DETAILED DESCRIPTION OF THE FIRST PREFERRED EMBODIMENT

The following detailed description of the first preferred embodiment is the preferred mode of carrying out the invention. The description is not to be taken in any limiting sense. It is presented for the purpose of illustrating the general principles of the present invention.

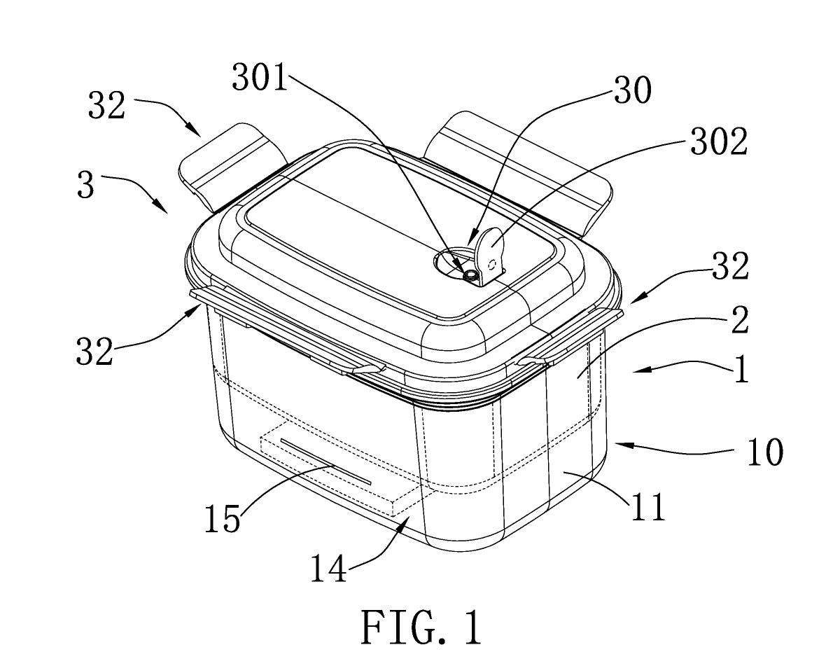

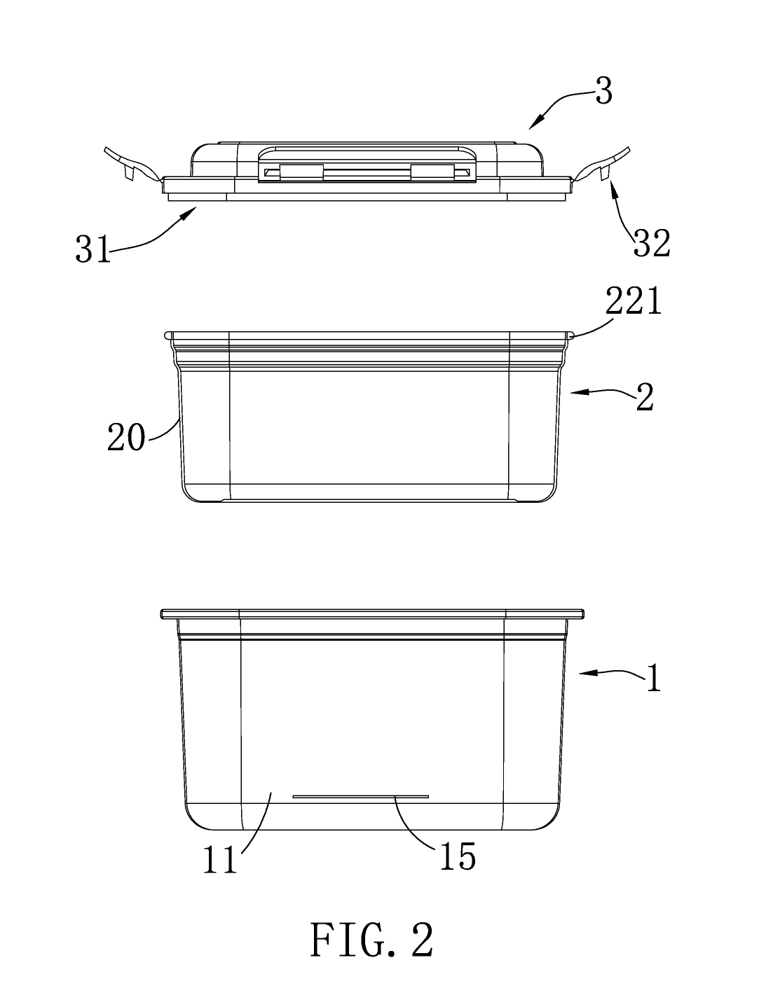

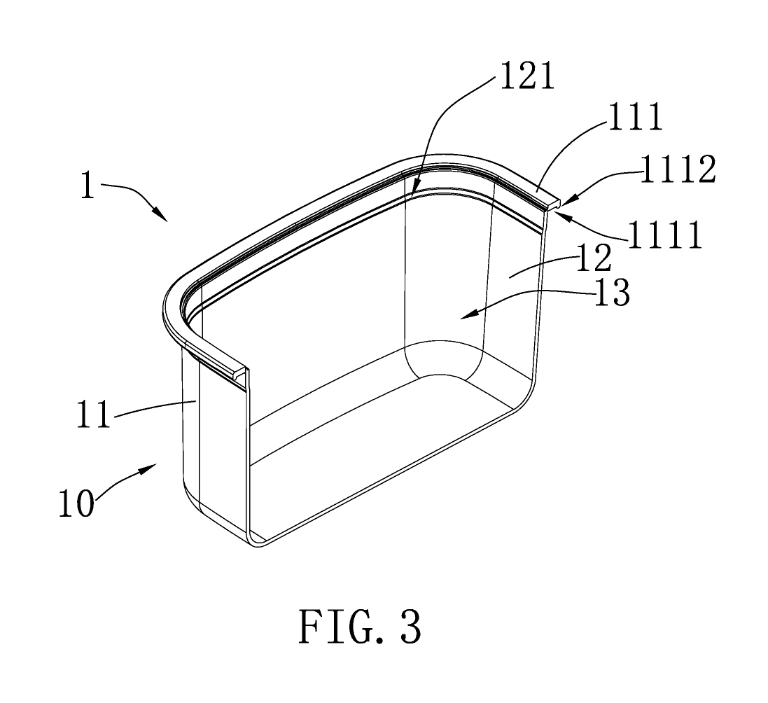

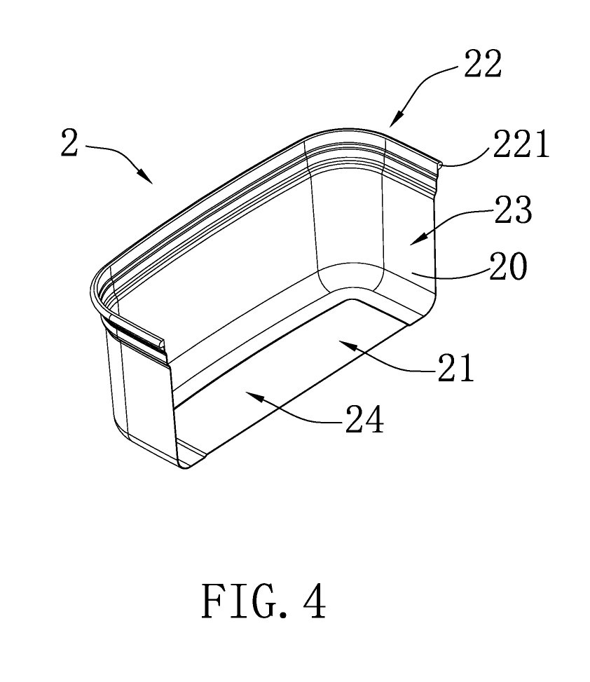

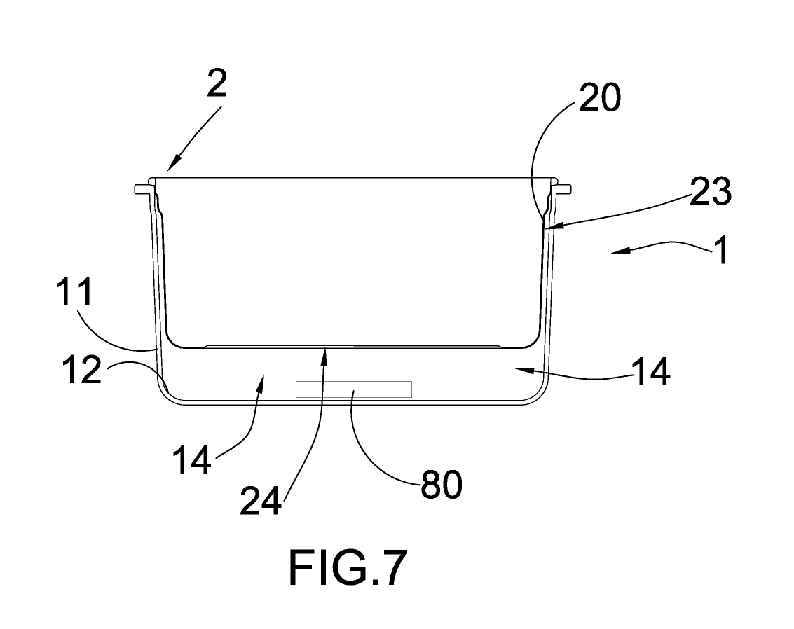

Referring to FIG. 1 to FIG. 11 of the drawings, a portable cooking container according to a first preferred embodiment of the present invention is illustrated. Broadly, the portable cooking container comprises an external container body 1, an internal container body 2, and a lid unit 3.

The external container body 1 comprises an external wall structure 10 having an external cavity 13 formed within the external wall structure 10. The external wall structure 10 comprises a first external surrounding wall 11 and a second external surrounding wall 12.

The internal container body 2 is detachably received in the external cavity 13, and has at least one internal surrounding wall 20 to define an internal cavity 21 within the internal surrounding wall 20. A height of the internal container body 2 is smaller than that of the external container body 1 to form a heating space 14 between the internal container body 2 and the external container body 1. Moreover, the internal container body has a rim arrangement 22 and a plurality of blocking sections 231, 232, 233 circumferentially formed on an upper portion of the internal container body 2. The external container body 1 and the internal container body 2 are separated by a predetermined distance.

The lid unit 3 is shaped and sized to fittedly cover the external container body 1, and comprises a venting mechanism 30 for allowing steam generated in the internal container body 2 to be vented out of the portable cooking container.

When a heating element 80 and water are placed in the heating space 14 and a food item is placed in the internal cavity 21, the heating element 80 is arranged to heat up the food item in the internal container body 2, in such a manner that water and steam in the heating space 14 is blocked by the blocking sections 231, 232, 233 so as to be prevented from splashing out of the portable cooking container, while steam in the internal container body 2 is guided to exit the portable cooking container through the venting mechanism 30.

According to the first preferred embodiment of the present invention, the portable cooking container is for use in conjunction with a predetermined amount of water and an existing cooking heat pack as a heating element 80. When the heating element 80 contacts with water, the heating element 80 will generate a predetermined amount of heat energy which heats up the water. The food item described above refers to any food or liquid contained in the internal container body 2.

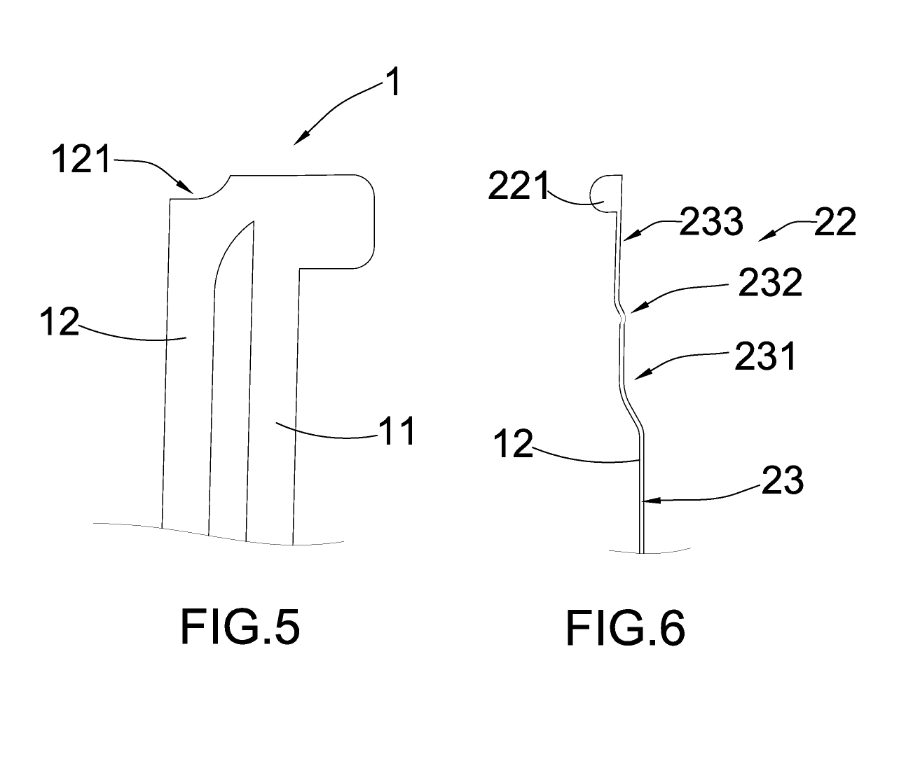

The external container body 1 is preferably configured from polycarbonate and is rigid in structure. Each of the first external surrounding wall 11 and the second external surrounding wall 12 forms an outer contour of the external container body 1. The external container body 1 may be configured to be transparent so that a user may be able to observe the water level in the external cavity 13. Moreover, the first external surrounding wall 11 and the second external surrounding wall 12 of the external wall structure 10 constitute a double-layered wall structure. It is worth mentioning that the first external surrounding wall 11 and the second external surrounding wall 12 may be welded together so as to form an integral body of the external wall structure (as shown in FIG. 5). The first external surrounding wall 11 and the second external surrounding wall 12 are spaced apart from each other at a predetermined distance.

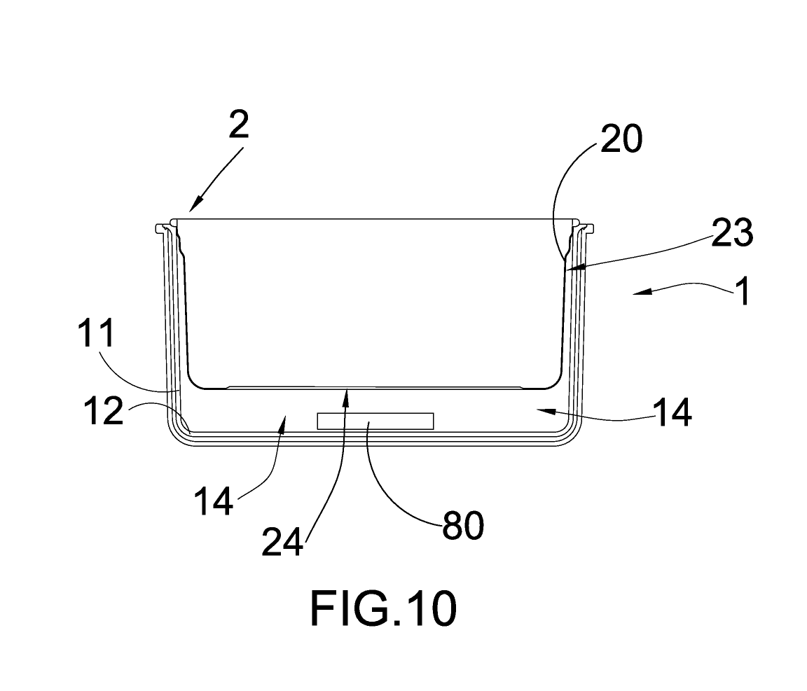

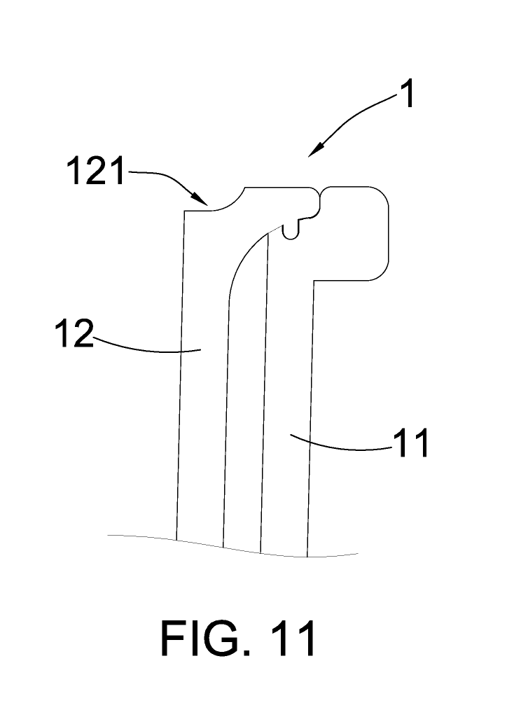

Alternatively, the first external surrounding wall 11 and the second external surrounding wall 12 may be detached from each other so that each of the first external surrounding wall 11 and the second external surrounding wall 12 form a distinct container, as shown in FIG. 10 to FIG. 11 of the drawings.

The purpose of having a double-layered wall structure is to provide proper thermal insulation of the external cavity 13 so that heat generated from the heated water in the heating space 14 is not capable of transmitting to an outer surface (the first external surrounding wall 11) of the external container body 1. This prevents users from contacting excessive heat generated from the heated water. Moreover, this arrangement also increases the efficiency of heating up the food item in the internal container body 2.

The external container body 1 further comprises an outer interlocking ridge 111 outwardly protruded along a peripheral edge of the first external surrounding wall 11, wherein the outer interlocking ridge 111 is arranged to interlock with the lid unit 3. Thus, the outer interlocking ridge 111 has an extension portion 1111 outwardly extended from the first external surrounding wall 11, and an interlocking portion 1112 downwardly extended from the extension portion 1111 to form a substantially L-shaped cross section of the outer interlocking ridge 111. The interlocking portion 1112 is for interlocking with the lid unit 3.

As shown in FIG. 5 of the drawings, a height of the first external surrounding wall 11 is slightly greater than that of the second external surrounding wall 12 so as to form a supporting seat 121 on the second external surrounding wall 12, wherein the internal container body 2 is arranged to be suspendedly supported on the supporting seat 121 when it is accommodated in the external cavity 13. Thus, in this particular embodiment of the present invention, the supporting seat 121 is embodied as a top edge of the second external surrounding wall 12.

On the other hand, the internal container body 2 is preferably configured from metallic material, such as stainless steel, for accommodating the food item. As mentioned above, the food item may comprise food or liquid, or both. The internal surrounding wall 20 has the peripheral side wall 23 and a bottom wall 24 for forming the internal cavity 21. The internal container body 2 has a cross sectional shape which is substantially the same as that of the external container body 1 so that the internal container body 2 can be fittedly supported within the external cavity 13.

The rim arrangement 22 comprises a supporting ridge 221 outwardly protruded from a top edge of the peripheral side wall 23 of the internal container body 2 for resting on the supporting seat 121 of the second external surrounding wall 12 when the internal container body 2 is accommodated in the external cavity 13. Thus, the supporting ridge 221 prevents the internal container body 2 from falling to the bottom of the external cavity 13, and thus structurally maintains a height of the internal container body 2 with respect to the external container body 1. The space created between the external container body 1 and the internal container body 2 constitutes the heating space 14 for accommodating the heating element 80 and a predetermined amount of water.

The peripheral side wall 23 further has a plurality of blocking sections 231, 232, 233 peripherally formed along a top portion thereof for stopping water from splashing out of the heating space 14 when it is heated up by the heating element 80. More specifically, each of the blocking sections 231, 232, 233 has a predetermined inclination with respect to a main portion of the peripheral side wall 23 so that when water is heated up in the heating space 14, the predetermined inclinations block the water from going further up along the peripheral side wall 23.

According to the first preferred embodiment of the present invention, the peripheral side wall 23 has first through third blocking sections 231, 232, 233 each of which has a predetermined inclination for blocking an upward flowing path of the heated water. As shown in FIG. 6 of the drawings, the main portion of the peripheral side wall 23 vertically extends from the bottom wall 24 to the blocking sections 231, 232, 233. The first blocking section 231 is outwardly inclined with respect to the vertically extending peripheral side wall 23 so as to decrease a horizontal distance between the peripheral side wall 23 and the second external surrounding wall 12. Furthermore, the second blocking section 232 has a slightly concave cross section when viewed from an exterior of the internal container body 2 for holding water which manages to pass through the first blocking section 231. Finally, the third blocking section 233 is substantially vertical for further preventing water from splashing out of the internal container body 2.

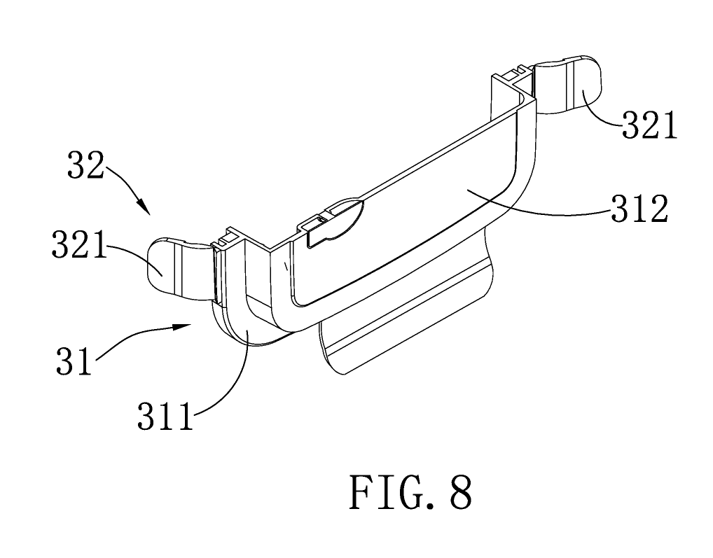

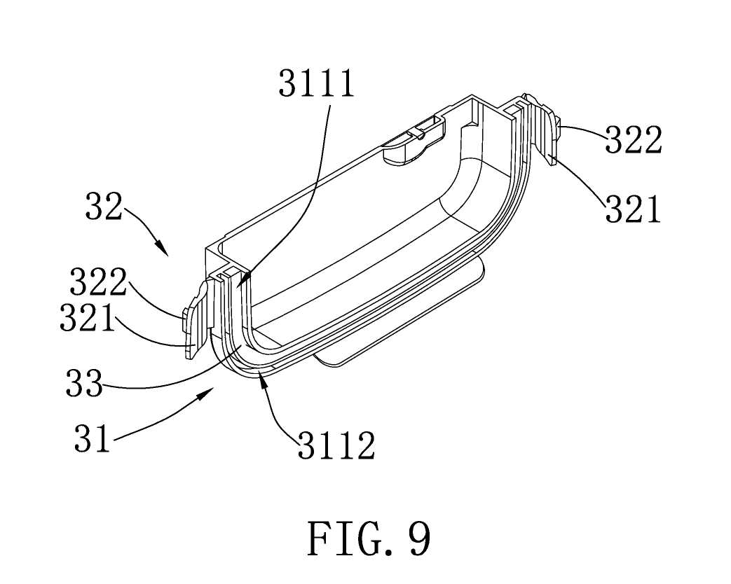

Referring to FIG. 8 to FIG. 9 of the drawings, the lid unit 3 comprises a lid body 31 and a plurality of engagement flaps 32 provided on four sides of the lid body 31 for selectively engaging with the internal container body 2. The lid body 31 comprises a peripheral rim member 311 and a top cap member 312 peripherally and upwardly extended from the peripheral rim 311 to form a concave structure of the lid unit 3. The peripheral rim member 311 has an inner sealing groove 3111 and an outer sealing groove 3112 indently formed on the rim member 311, wherein the inner sealing groove 3111 and the outer sealing groove 3112 have a substantially identical contour.

The lid unit 3 further comprises a sealing member 33 fittedly accommodated in the inner sealing groove 3111 for preventing steam from escaping from the internal cavity 21. Thus, the sealing member 33 is shaped and sized to correspond with the shape and size of the supporting ridge 221. When the lid unit 3 is engaged with the internal container body 2, the sealing member 33 is arranged to prevent steam generated in the internal cavity 21 from escaping through the gap between the lid unit 3 and the external container body 1.

On the other hand, each of the engagement flaps 32 comprises a flap member 321 movably extended from the corresponding side of the peripheral rim member 311, and at least one engaging member 322 inwardly extended from the flap member 321 for detachably engaging with the interlocking portion 1112 of the outer interlocking ridge 111 of the first external surrounding wall 11. Note that each of the engagement flaps 32 has a predetermined elasticity for allowing slight deformation so that a user is able engage or disengage the engaging member 322 with the or from the interlocking portion 1112 by using a slight pushing force or pulling force.

The venting mechanism 30 contains a venting slot 301 formed on the top cap member 312 and a venting member 302 movably extended from the top cap member 312 for selectively covering the venting slot 301. Since the sealing member 33 prevents steam generated in the internal cavity 21 from escaping, the steam can only leave the internal cavity 21 through the venting slot 301 when the lid unit 3 is engaged with the external container body 1.

The operation of the present invention is as follows: a heating element 80 is placed in the heating space 14 and a desirable amount of food items (food or liquid) may be placed in the internal cavity 21. A user needs to pour a predetermined amount of water in the heating space 14 as indicated by an indicator mark 15 provided on the external container body 1. When the heating element 80 mixes with water, heat will be generated in the heating space 14 which heats up the internal cavity 21. At the same time, the user needs to cover the external container body 1 and the internal container body 2 by the lid unit 3. The heat generated by the heating element 80 is used to heat the food item in the internal cavity 21 while steam will escape through the space between the internal container body 2 and the external container body 1. However, the water in the heating space 14 will be retained in the heating space by the rim arrangement 22. On the other hand, the steam generated in the internal cavity 21 will exit the portable cooking container via the venting mechanism 30.

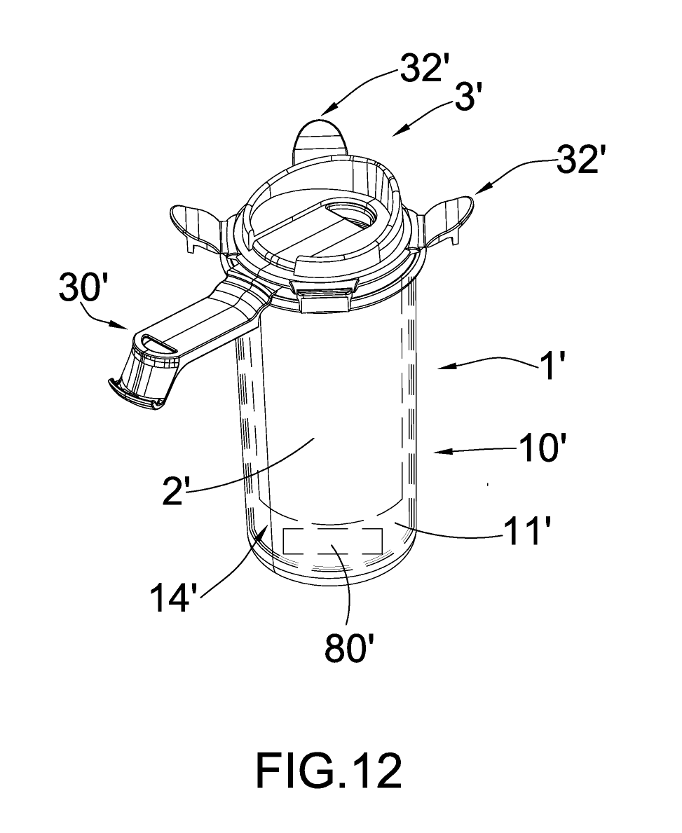

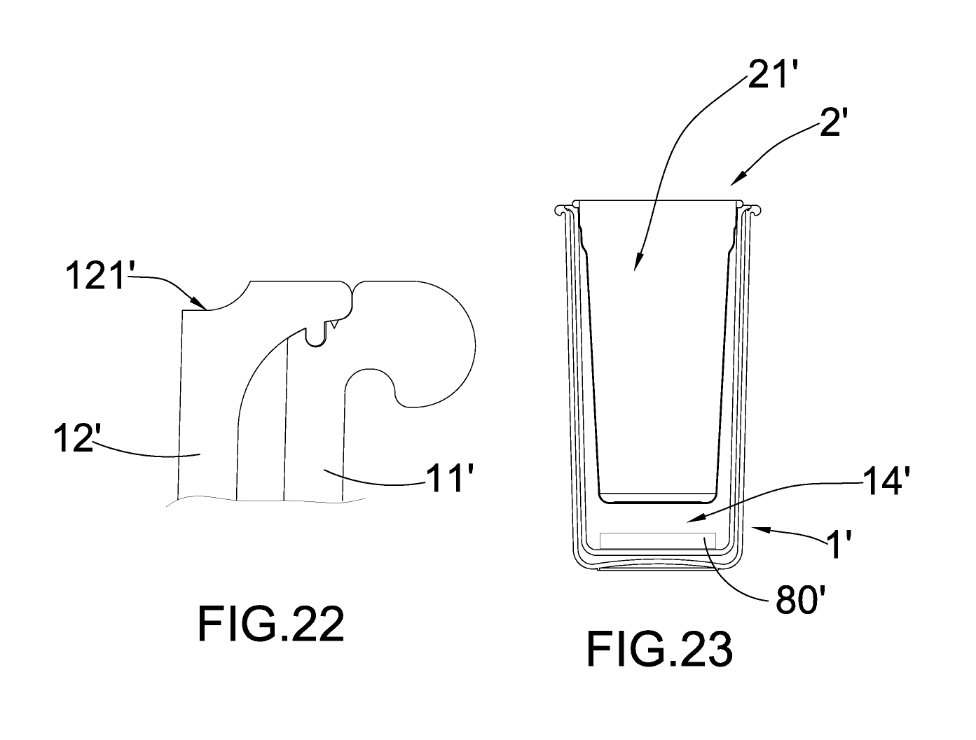

Referring to FIG. 12 to FIG. 23 of the drawings, a portable cooking container according to a second preferred embodiment of the present invention is illustrated. The second preferred embodiment is substantially the same as the first preferred embodiment, except that the second preferred embodiment is configured as a cup. The portable cooking container comprises an external container body 1′, an internal container body 2′, and a lid unit 3′.

The external container body 1′ comprises an external wall structure 10′ having an external cavity 13′ formed within the external wall structure 10′. The external wall structure 10′ comprises a first external surrounding wall 11′ and a second external surrounding wall 12′.

The internal container body 2′ is detachably received in the external cavity 13′, and has at least one internal surrounding wall 20′ to define an internal cavity 21′ within the internal surrounding wall 20′. A height of the internal container body 2′ is smaller than that of the external container body 1′ to form a heating space 14′ between the internal container body 2′ and the external container body 1′. Moreover, the internal container body has a rim arrangement 22′ and a plurality of blocking sections 231′, 232′, 233′ circumferentially formed on an upper portion of the internal container body 2′. The external container body 1′ and the internal container body 2′ are separated by a predetermined distance.

The lid unit 3′ is shaped and sized to fittedly cover the external container body 1′, and comprises a venting mechanism 30′ for allowing fluid contained in the internal container body 2′ to be discharged out of the portable cooking container.

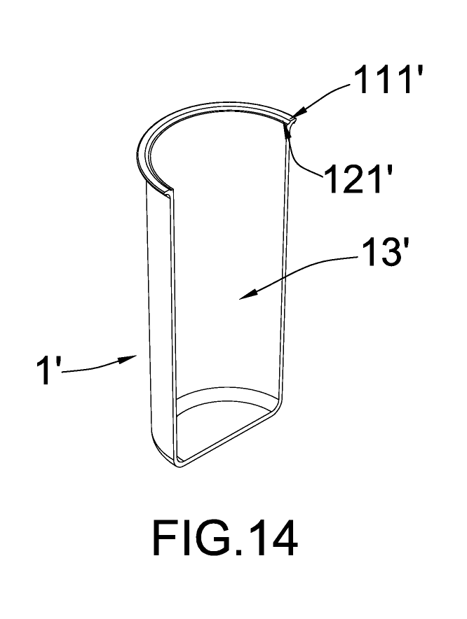

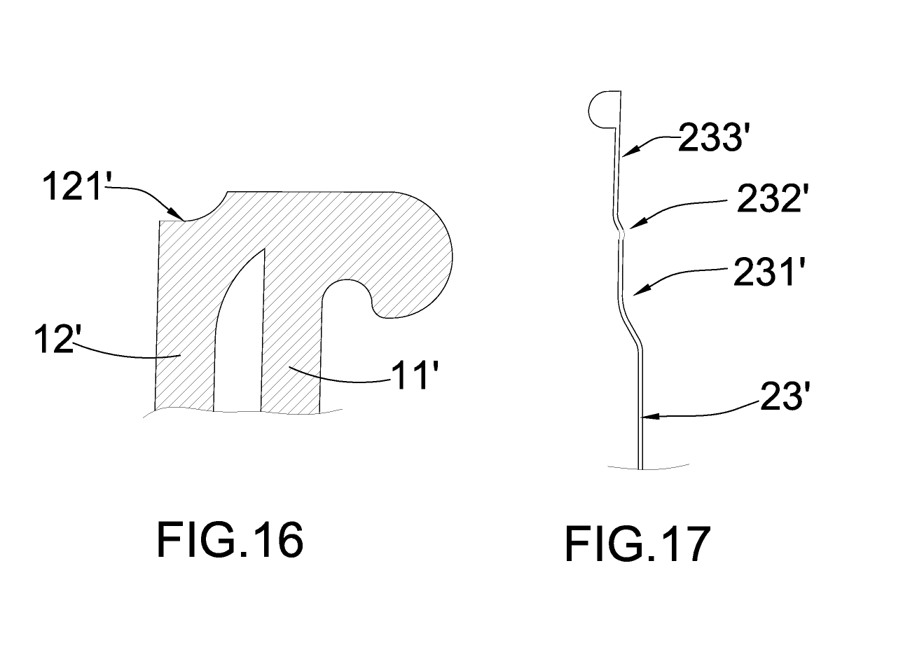

As in the first preferred embodiment, the external container body 1′ is preferably configured from polycarbonate and is rigid in structure and transparent. Each of the first external surrounding wall 11′ and the second external surrounding wall 12′ forms an outer contour of the external container body 1′. The first external surrounding wall 11′ and the second external surrounding wall 12′ of the external wall structure 10′ constitute a double-layered wall structure. It is worth mentioning that the first external surrounding wall 11′ and the second external surrounding wall 12′ may be welded together so as to form an integral body of the external wall structure (see FIG. 14 and FIG. 16). The first external surrounding wall 11′ and the second external surrounding wall 12′ are spaced apart from each other at a predetermined distance.

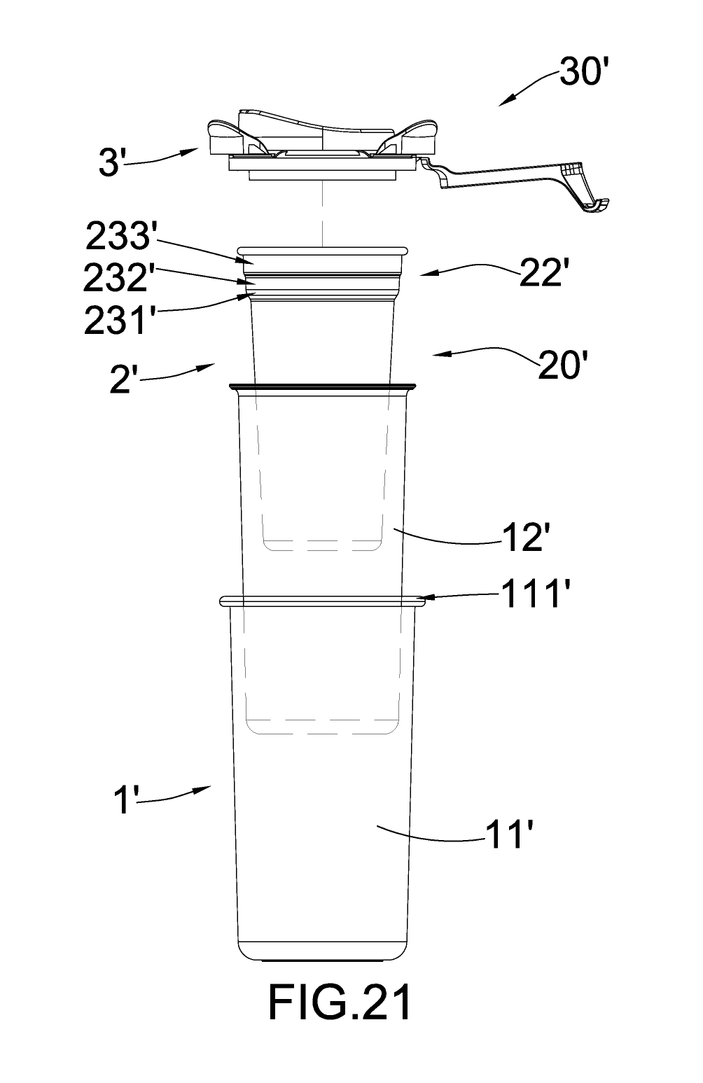

Alternatively, the first external surrounding wall 11′ and the second external surrounding wall 12′ may be detached from each other so that each of the first external surrounding wall 11′ and the second external surrounding wall 12′ form a distinct container, as shown in FIG. 21 to FIG. 23 of the drawings.

The external container body 1′ further comprises an outer interlocking ridge 111′ outwardly protruded along a peripheral edge of the first external surrounding wall 11′, wherein the outer interlocking ridge 111′ is arranged to interlock with the lid unit 3′.

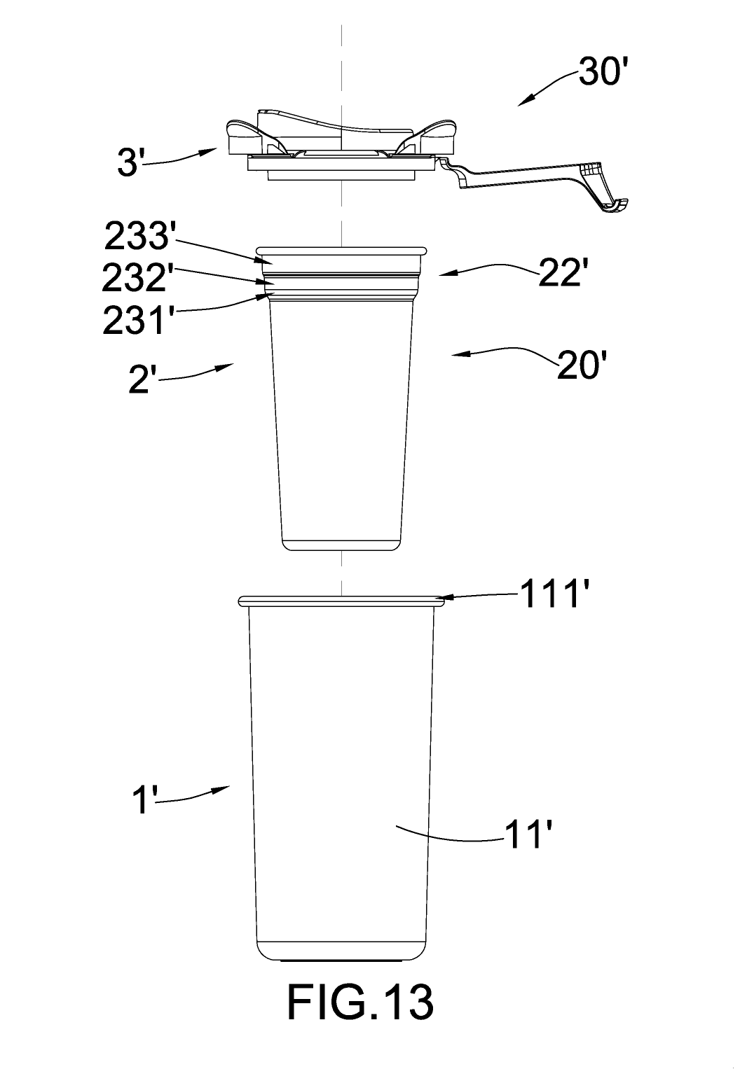

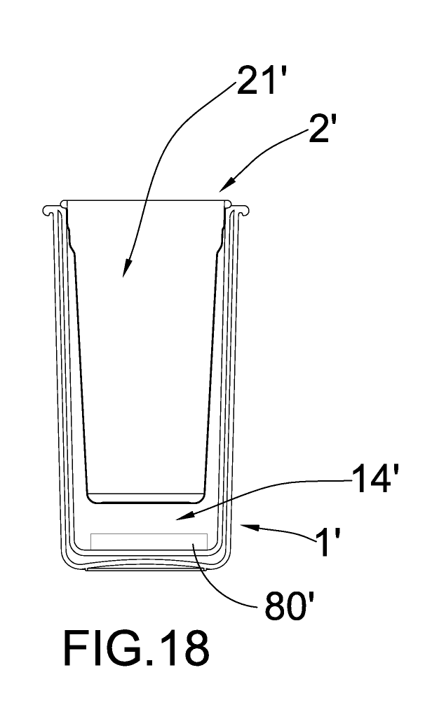

As shown in FIG. 12, FIG. 13 and FIG. 18 of the drawings, a height of the first external surrounding wall 11′ is slightly greater than that of the second external surrounding wall 12′ so as to form a supporting seat 121′ on the second external surrounding wall 12′, wherein the internal container body 2′ is arranged to be suspendedly supported on the supporting seat 121′ when it is accommodated in the external cavity 13′. Thus, in this particular embodiment of the present invention, the supporting seat 121′ is embodied as a top edge of the second external surrounding wall 12′.

Moreover, the internal container body 2′ is configured from metallic material, such as stainless steel, for accommodating the food item. As mentioned above, the food item may comprise food or liquid, or both. The internal surrounding wall 20′ has a peripheral side wall 23′ and a bottom wall 24′ for forming the internal cavity 21′. The internal container body 2′ has a cross sectional shape which is substantially the same as that of the external container body 1′ so that the internal container body 2′ can be fittedly supported within the external cavity 13′.

The rim arrangement 22′ comprises a supporting ridge 221′ outwardly protruded from a top edge of the peripheral side wall 22′ of the internal container body 2′ for resting on the supporting seat 121′ of the second external surrounding wall 12′ when the internal container body 2′ is accommodated in the external cavity 13′. Thus, the supporting ridge 221′ prevents the internal container body 2′ from falling to the bottom of the external cavity 13′, and thus structurally maintains a height of the internal container body 2′ with respect to the external container body 1′. The space created between the external container body 1′ and the internal container body 2′ constitutes the heating space 14′ for accommodating the heating element 80′ and a predetermined amount of water.

The peripheral side wall 23′ further has a plurality of blocking sections 231′, 232′, 233′ peripherally formed along a top portion thereof for stopping water from splashing out of the heating space 14′ when it is heated up by the heating element 80′. More specifically, each of the blocking sections 231′ has a predetermined inclination with respect to a main portion of the peripheral side wall 23′ so that when water is heated up in the heating space 14′, the predetermined inclinations block the water from going further up along the peripheral side wall 23′.

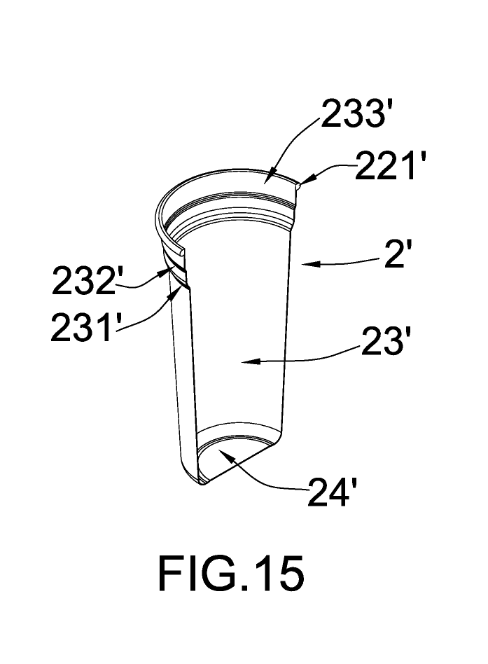

The peripheral side wall 23′ has first through third blocking sections 231′, 232′, 233′ each of which has a predetermined inclination for blocking an upward flowing path of the heated water. As shown in FIG. 15 and FIG. 17 of the drawings, the main portion of the peripheral side wall 23′ vertically extends from the bottom wall 24′ to the blocking sections 231′. The first blocking section 231′ is outwardly inclined with respect to the vertically extending peripheral side wall 23′ so as to decrease a horizontal distance between the peripheral side wall 23′ and the second external surrounding wall 12′. Furthermore, the second blocking section 232′ has a slightly concave cross section when viewed from an exterior of the internal container body 2′ for holding water which manages to pass through the first blocking section 231′. Finally, the third blocking section 233′ is substantially vertical for further preventing water from splashing out of the internal container body 2′.

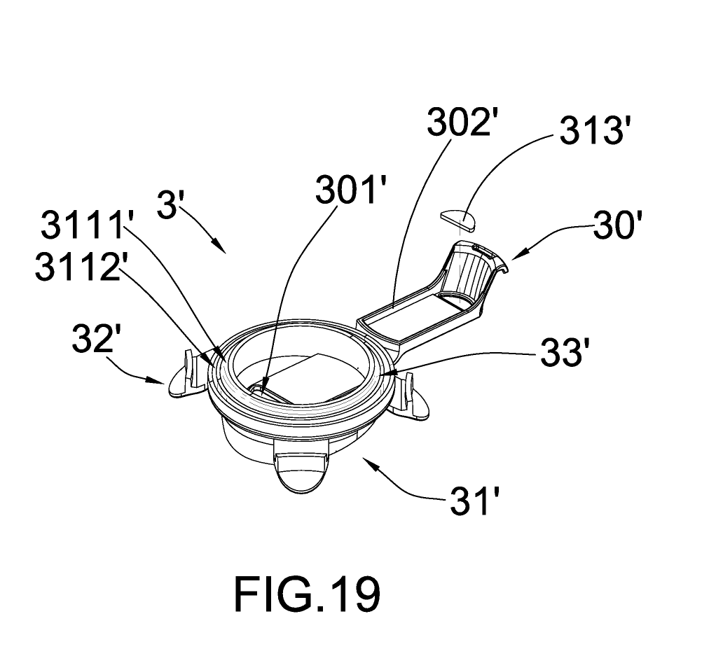

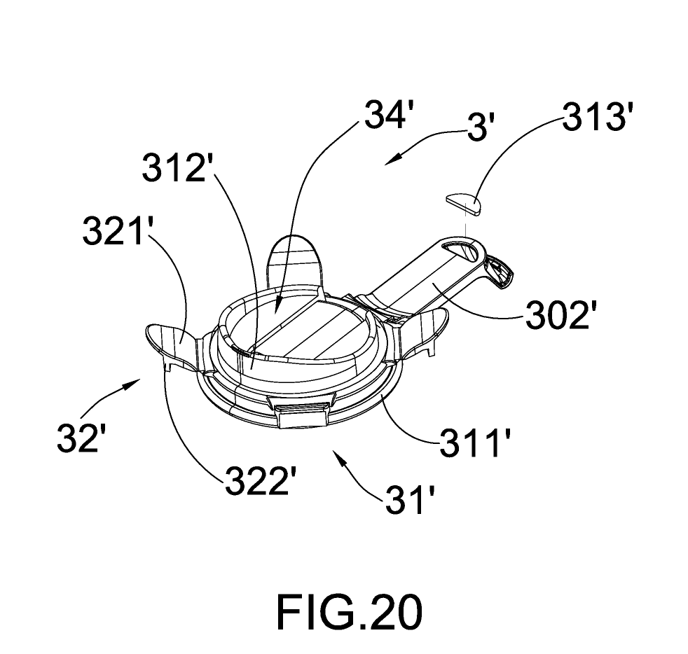

Referring to FIG. 19 to FIG. 20 of the drawings, the lid unit 3′ comprises a lid body 31′ and a plurality of engagement flaps 32′ provided on the lid body 31′ for selectively engaging with the internal container body 2′. The lid body 31′ comprises a lid cover 311′ and a top enclosure member 312′ upwardly extended from the peripheral rim 311′ to form a lid cavity 34′ of the lid unit 3′. The lid cover 311′ has an inner sealing groove 3111′ and an outer sealing groove 3112′ indently formed on a bottom side of the lid cover 311′, wherein the inner sealing groove 3111′ and the outer sealing groove 3112′ have a substantially identical contour.

The lid unit 3′ further comprises a sealing member 33′ fittedly accommodated in the inner sealing groove 3111′ for preventing steam from escaping from the internal cavity 21′. Thus, the sealing member 33′ is shaped and sized to correspond with the shape and size of the supporting ridge 221′.

On the other hand, each of the engagement flaps 32′ comprises a flap member 321′ movably extended from the lid cover 311′, and at least one engaging member 322′ inwardly extended from the flap member 321′ for detachably engaging with the interlocking portion 1112′ of the outer interlocking ridge 111′ of the first external surrounding wall 11′. Each of the engagement flaps 32′ has a predetermined elasticity for allowing slight deformation so that a user is able engage or disengage the engaging member 322′ with the or from the interlocking portion 1112′ by using a slight pushing force or pulling force.

The venting mechanism 30′ contains a venting slot 301′ formed on the lid cover 311′ and an elongated venting member 302′ having one end movably extended from the lid cover 311′, and another end detachably engaged with the top enclosure member 312′ for selectively covering the venting slot 301′. In the second preferred embodiment of the present invention, the venting mechanism 30′ is used for allowing a user to drink the liquid contained in the internal cavity 21′ by overturning the portable cooking container. The venting mechanism 30′ further comprises a sealing element 313′ provided on the elongated venting member 302′ in such a manner when the elongated venting member 302′ is moved to engage with the top enclosure member 312′, the sealing element 313′ is arranged to cover the venting slot 301′ for preventing liquid from accidentally escaping out of the internal cavity 21′ through the venting slot 301′.

The major difference between the first preferred embodiment and the second preferred embodiment is that in the first preferred embodiment, the portable cooking container is to be utilized as a cooking lunch box (i.e. having a substantially cubic or rectangular structure), whereas in the second preferred embodiment, the portable cooking container is to be utilized as a heating cup (i.e. having a substantially tubular structure). However, it is important to point out that the two embodiments of the present invention are based on the same inventive concept.

The present invention, while illustrated and described in terms of a first and second preferred embodiments and several alternatives, is not limited to the particular description contained in this specification. Additional alternative or equivalent components could also be used to practice the present invention.

What is claimed is:

1. A portable cooking container, comprising:
an external container body comprising an external wall structure having an external cavity formed within said external wall structure, said external wall structure comprising a first external surrounding wall and a second external surrounding wall;
an internal container body detachably received in said external cavity, said internal container body having at least one internal surrounding wall to define an internal cavity within said internal surrounding wall, a height of said internal container body being smaller than that of said external container body to form a heating space between said internal container body and said external container body, said internal container body having a plurality of blocking sections circumferentially formed on an upper portion of said internal container body, said external container body and said internal container body being separated by a predetermined distance; and
a lid unit being shaped and sized to fittedly cover said external container body, said lid unit comprising a venting mechanism for allowing fluid in said internal cavity to be discharged out of said portable cooking container;
whereby when a heating element and water are placed in said heating space and a food item is placed in said internal cavity, said heating element is arranged to heat up said food item in said internal container body, in such a manner that water and steam in said heating space is blocked by said blocking sections from splashing out of said portable cooking container, while fluid in said internal container body is guided to exit said portable cooking container through said venting mechanism.

2. The cooking container, as recited in claim 1, wherein said external container body further comprises an outer interlocking ridge outwardly protruded along a peripheral edge of said first external surrounding wall, said outer interlocking ridge being arranged to interlock with said lid unit.

3. The cooking container, as recited in claim 2, wherein said outer interlocking ridge has an extension portion outwardly extended from said first external surrounding wall, and an interlocking portion downwardly extended from said extension portion to form a substantially L-shaped cross section of said outer interlocking ridge.

4. The cooking container, as recited in claim 1, wherein a height of said first external surrounding wall is slightly greater than that of said second external surrounding wall so as to form a supporting seat on said second external surrounding wall, said internal container body being arranged to be suspendedly supported on said supporting seat.

5. The cooking container, as recited in claim 4, wherein said rim arrangement comprises a supporting ridge outwardly protruded from a top edge of said peripheral side wall of said internal container body for resting on said supporting seat of said second external surrounding wall.

6. The cooking container, as recited in claim 5, wherein said peripheral side wall of said internal container body further has a plurality of blocking sections peripherally formed along a top portion thereof for stopping said water from splashing out of said heating space when said water is heated up by said heating element, each of said blocking sections having a predetermined inclination with respect to said peripheral side wall, so that when said water is heated up in said heating space, said predetermined inclinations block said water from going further up along said peripheral side wall.

7. The cooking container, as recited in claim 6, wherein said peripheral side wall has first through third blocking sections, said first blocking section being outwardly inclined with respect to said vertically extending peripheral side wall so as to decrease a horizontal distance between said peripheral side wall and said second external surrounding wall, said second blocking section having a slightly concave cross section for substantially holding said water which manages to pass through said first blocking section, said third blocking section being substantially vertical for further preventing water from splashing out of said internal container body.

8. The cooking container, as recited in claim 1, wherein said lid unit comprises a lid body and a plurality of engagement flaps provided on four sides of said lid body for selectively engaging with said internal container body.

9. The cooking container, as recited in claim 8, wherein said lid body comprises a peripheral rim member and a top cap member peripherally and upwardly extended from said peripheral rim to form a concave structure of said lid unit, said peripheral rim member having an inner sealing groove and an outer sealing groove indently formed on said rim member, said inner sealing groove and said outer sealing groove having a substantially identical contour.

10. The cooking container, as recited in claim 9, wherein said lid unit further comprises a sealing member fittedly accommodated in said inner sealing groove for preventing steam from escaping from said internal cavity.

11. The cooking container, as recited in claim 10, wherein each of said engagement flaps comprises a flap member movably extended from said corresponding side of said peripheral rim member, and at least one engaging member inwardly extended from said flap member for detachably engaging with said interlocking portion of said outer interlocking ridge of said first external surrounding wall.

12. The cooking container, as recited in claim 1, wherein said venting mechanism contains a venting slot formed on said top cap member and a venting member movably extended from said top cap member for selectively covering said venting slot.

13. The cooking container, as recited in claim 1, wherein said lid unit comprises a lid body and a plurality of engagement flaps provided on said lid body for selectively engaging with said internal container body, said lid body comprising a lid cover and a top enclosure member upwardly extended from said peripheral rim to form a lid cavity of said lid unit, said lid cover having an inner sealing groove and an outer sealing groove indently formed on a bottom side of said lid cover, said inner sealing groove and said outer sealing groove having a substantially identical contour.

14. The cooking container, as recited in claim 1, wherein said venting mechanism contains a venting slot formed on said lid cover and comprises an elongated venting member having one end movably extended from said lid cover, and another end detachably engaged with said top enclosure member for selectively covering said venting slot, said venting mechanism further comprising a sealing element provided on said elongated venting member in such a manner when said elongated venting member is moved to engage with said top enclosure member, said sealing element is arranged to cover said venting slot.

15. The cooking container, as recited in claim 1, wherein said external container body is configured from polycarbonate and is rigid in structure, said first external surrounding wall and said second external surrounding wall of said external wall structure are welded together at a top portion of said first external surrounding wall and said second external surrounding wall so as to constitute a double-layered wall structure.

16. The cooking container, as recited in claim 7, wherein said external container body is configured from polycarbonate and is rigid in structure, said first external surrounding wall and said second external surrounding wall of said external wall structure are welded together at a top portion of said first external surrounding wall and said second external surrounding wall so as to constitute a double-layered wall structure.

17. The cooking container, as recited in claim 14, wherein said external container body is configured from polycarbonate and is rigid in structure, said first external surrounding wall and said second external surrounding wall of said external wall structure are welded together at a top portion of said first external surrounding wall and said second external surrounding wall so as to constitute a double-layered wall structure.

18. The cooking container, as recited in claim 1, wherein said first external surrounding wall and said second external surrounding wall are detachable from each other so that each of said first external surrounding wall and said second external surrounding wall form two distinct containers respectively.

19. The cooking container, as recited in claim 7, wherein said first external surrounding wall and said second external surrounding wall are detachable from each other so that each of said first external surrounding wall and said second external surrounding wall form two distinct containers respectively.

20. The cooking container, as recited in claim 14, wherein said first external surrounding wall and said second external surrounding wall are detachable from each other so that each of said first external surrounding wall and said second external surrounding wall form two distinct containers respectively.
